(19) United States
(12) Patent Application Publication
(10) Pub. No.: US 2020/0306784 A1
(43) Pub. Date: Oct. 1, 2020

(54) APPARATUS FOR CLEANING A SHOWERHEAD

(71) Applicant: Lyndsey BRASSEUR, Sherwood Park (CA)

(72) Inventor: Lyndsey BRASSEUR, Sherwood Park (CA)

(21) Appl. No.: 16/551,874

(22) Filed: Aug. 27, 2019

(30) Foreign Application Priority Data
Apr. 1, 2019 (CA) 3 038 576

(51) Int. Cl. B05B 15/55; B08B 3/08

(52) U.S. Cl. CPC B05B 15/55; B08B 3/08

(57) ABSTRACT

An apparatus for cleaning a showerhead has a bag made of a flexible material with an opening, a bottom surface and a peripheral side wall. At least a portion of the peripheral side wall is pleated to allow the peripheral side wall and the opening to expand and contract in size. A closing mechanism is provided for closing the opening of the bag.

### FIELD OF THE DISCLOSURE

The present application relates generally to an apparatus for cleaning a faucet, in particular an apparatus for cleaning showerheads of various sizes.

### BACKGROUND

This section provides background information to facilitate a better understanding of the various aspects of the invention. It should be understood that the statements in this section of this document are to be read in this light, and not as admissions of prior art.

Over time, showerheads and faucets become clogged by mineral deposits which negatively affects flow through the showerhead or faucet. People commonly use a large plastic bag filled with a descaling liquid, such as white vinegar, and place it over the showerhead and attach it to the neck of the faucet with a rubber band. Because the showerhead is much broader than the neck, it is challenging to secure the rubber band tightly. As a consequence, the bag sags downwards which results in poor saturation of the showerhead with the descaling fluid and an overall lack of stability. An alternative method involves wrapping cotton wool soaked in descaling liquid around the faucet or showerhead. This method merely cleans the surface of the faucet and does not allow the descaling liquid to penetrate into an interior of the showerhead. A further alternative of cleaning requires that the faucet to be cleaned be dismantled, which is both time consuming and inconvenient.

### BRIEF SUMMARY

There is provided an apparatus for cleaning a showerhead that has a bag made of a flexible material. The bag has an opening, a bottom surface and a peripheral side wall. At least a portion of the peripheral side wall is pleated to allow the peripheral side wall and the opening to expand and contract in size. A closing mechanism is provided for closing the opening of the bag.

In one embodiment, the peripheral side wall has ten pleats. More or fewer pleats may also be used.

In one embodiment, a filling port is positioned within the peripheral side wall to allow for filling of the bag with fluid. The bag will generally be filled with a descaling fluid, however other fluids may be used. Filling port may also be used to drain fluid out of bag. A filling cap may be provided for closing the filling port to prevent fluid from exiting the bag through the filling port.

In one embodiment, the closing mechanism is a buckle clamp, Velcro strap or tie. It will be understood that other types of closing mechanisms may also be used.

In one embodiment, the bag is made of a translucent material. The translucent material allows the user to see how much fluid is in the bag and, therefore, allows them to fill the bag with the desired amount of fluid. It is also beneficial for the bag to be made of a chemically resistant material so that the descaling and cleaning fluids used do not cause undue catastrophic damage to the bag.

In one embodiment, a fluid reservoir is provided at the bottom of the bag. The fluid reservoir acts to expand the capacity of the bag for holding the descaling or cleaning fluid. The fluid reservoir may, or may not, also have pleats.

In one embodiment, the bottom surface is stiff. This prevents the bag from sagging downwards due to the weight of the descaling or cleaning fluid and maintains the fluid in a proper position for saturation of the showerhead or faucet.

### BRIEF DESCRIPTION OF THE DRAWINGS

These and other features will become more apparent from the following description in which references are made to the following drawings, in which numerical references denote like parts. The drawings are for the purpose of illustration only and are not intended to in any way limit the scope of the invention to the particular embodiments shown.

FIG. 1 is a front elevation view of the apparatus for cleaning a shower with the closing mechanism secured.

FIG. 2 is a rear elevation view of the apparatus for cleaning a shower with the closing mechanism unsecured.

FIG. 3 is a front elevation view of the apparatus for cleaning a shower with the closing mechanism unsecured and the filling port opened.

FIG. 4 is a top plan view of the apparatus for cleaning a shower with the closing mechanism unsecured.

### DETAILED DESCRIPTION OF THE PREFERRED EMBODIMENTS

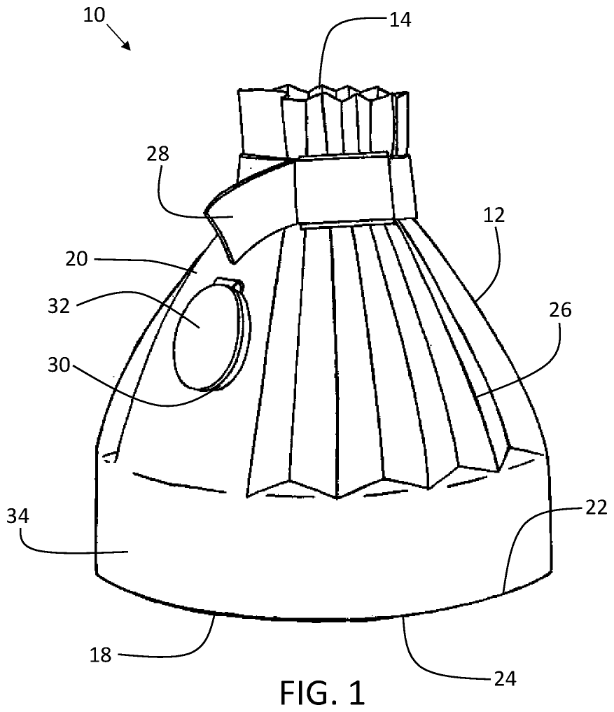

An apparatus for cleaning a shower, generally identified by reference numeral 10, will now be described with reference to FIG. 1 through FIG. 4.

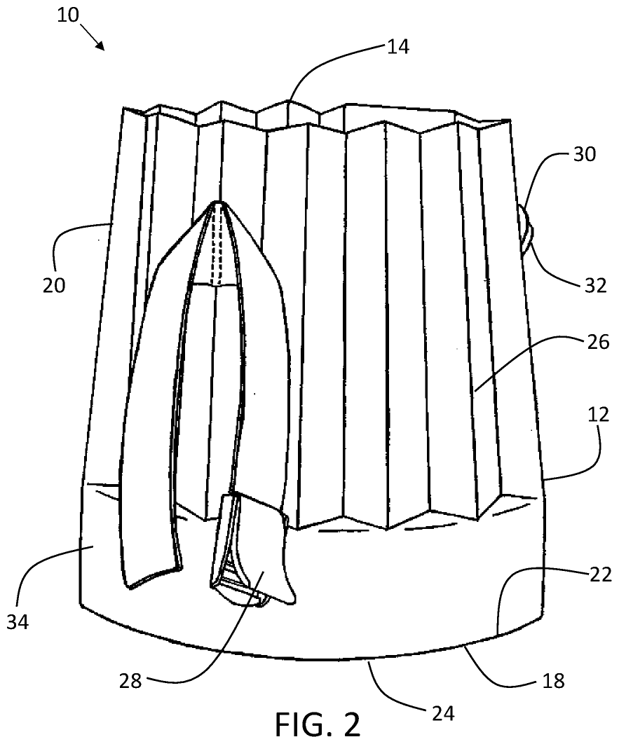

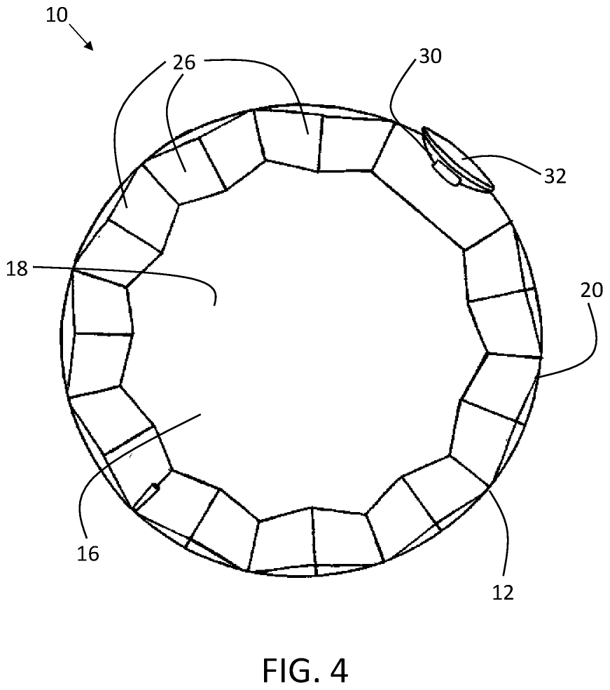

Referring to FIG. 1, an apparatus for cleaning a shower 10 has a bag 12 made of a flexible material. Material used to make bag 12 should be relatively impervious to fluid so that fluid does not leak out of it during use. It may be beneficial for the material to be a translucent material as this would allow a user to see into the interior of bag 12 when adding fluid to bag 12 for cleaning. It may also be beneficial for the material to be a chemically resistant material, such as silicon, to prevent undue wear and damage to the bag during normal use. Referring to FIG. 4, bag 12 has an opening 14 which allows access to an interior 16 of bag 12, a bottom surface 18 and a peripheral side wall 20. Referring to FIG. 2, a bottom edge 22 of peripheral side wall 20 is attached to an outer edge 24 of bottom surface 18 in such a manner as to prevent the leaking of fluids from edges 22 and 24. A person of skill will understand that various methods of attaching peripheral side wall 20 to bottom surface 18 are possible. Peripheral side wall 20 may also be continuously formed with bottom surface 18 such that no attachment between them is necessary. This eliminates the risk of leaking along edges 22 and 24. In a preferred embodiment, bottom surface 18 is stiff to limit sagging when bag 12 has fluid in it. This helps to keep fluid in contact with the showerhead or faucet and can help provide greater cleaning capabilities as the showerhead or faucet is submerged within fluid.

Peripheral side wall 20 has pleats 26 that allow peripheral side wall 20 and opening 14 to expand and contract in size. Referring to FIG. 4, in the embodiment shown, ten pleats are used. It will be understood by a person skilled in the art that a greater number or a smaller number of pleats may be used. This allows a single apparatus 10 to be adaptable for use on different sized showerheads and faucets. It also allows opening 14 to be closed around a surface with a diameter smaller than the showerhead or faucet that is being cleaned. Referring to FIG. 1, a closing mechanism 28 is provided for closing opening 14 of bag 12. In the embodiment shown, closing mechanism 28 is a buckle clamp. It will be understood by a person skilled in the art that closing mechanism may be a Velcro strap, a tie or any other suitable mechanism for closing opening 14 of bag 12. A fluid reservoir 34 may be provided to increase the capacity of bag 12. In the embodiments shown, fluid reservoir 34 is not pleated however it will be understood that fluid reservoir 34 could be pleated.

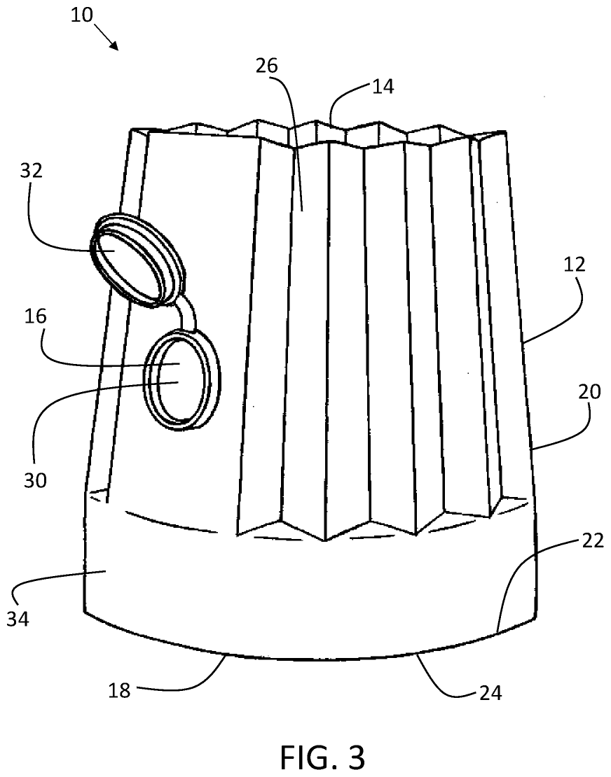

In the embodiments shown, a filling port 30 is provided and positioned within peripheral side wall 20 to allow for filling of bag 12 with fluid after it has been secured by closing mechanism 28 to a showerhead or faucet. It will be understood that positioning filling port 30 higher up on peripheral side wall 20 or orienting bag 12 such that filling port 30 is at a top of showerhead or faucet will allow more fluid to be held within bag 12. Use of filling port 30 to add fluid to bag 12 may be facilitated through the use of a funnel, not shown. A filling cap 32 opens, shown in FIG. 3, or closes, shown in FIG. 1, filling port 30 and reduces or eliminates the possibility of fluid escaping through filling port 30 when in the closed position.

Any use herein of any terms describing an interaction between elements is not meant to limit the interaction to direct interaction between the subject elements, and may also include indirect interaction between the elements such as through secondary or intermediary structure unless specifically stated otherwise.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent that changes may be made to the illustrative embodiments, while falling within the scope of the invention. As such, the scope of the following claims should not be limited by the preferred embodiments set forth in the examples and drawings described above, but should be given the broadest interpretation consistent with the description as a whole.

What is claimed is:

1. An apparatus for cleaning a showerhead, comprising:
a bag being made of a flexible material having an opening, a bottom surface and a peripheral side wall, at least a portion of the peripheral side wall being pleated to allow the peripheral side wall and the opening to expand and contract in size;
a closing mechanism for closing the opening of the bag.

2. The apparatus of claim 1 wherein there are ten pleats.

3. The apparatus of claim 1 wherein a filling port is positioned within the peripheral side wall to allow for filling of the bag with fluid.

4. The apparatus of claim 3 wherein a filling cap is provided for closing the filling port.

5. The apparatus of claim 1 wherein the closing mechanism is a buckle clamp.

6. The apparatus of claim 1 wherein the closing mechanism is a Velcro strap.

7. The apparatus of claim 1 wherein the closing mechanism is a tie.

8. The apparatus of claim 1 wherein the bag is made of a translucent material.

9. The apparatus of claim 1 wherein the bag is made of a chemically resistant material.

10. The apparatus of claim 1 further comprising a fluid reservoir.

11. The apparatus of claim 1 wherein the bottom surface is stiff.
